(19) United States
(12) Patent Application Publication
(10) Pub. No.: US 2023/0274304 A1
(43) Pub. Date: Aug. 31, 2023

(54) MERGING A TWO OR MORE MULTI-LEVEL USER STRUCTURES INTO A MULTI-LINE USER STRUCTURE AND SIMULATING SPONSORSHIP OF NEW MEMBERS

(71) Applicant: KWIKCLICK, LLC, Murray, UT (US)

(72) Inventor: Fred Cooper, Farmington, UT (US)

(21) Appl. No.: 18/090,473

(22) Filed: Dec. 28, 2022

Related U.S. Application Data
(63) Continuation-in-part of application No. 17/868,457, filed on Jul. 19, 2022.
(60) Provisional application No. 63/223,317, filed on Jul. 19, 2021.

(51) Int. Cl. G06Q 30/0214; G06Q 30/0211

(52) U.S. Cl. CPC G06Q 30/0214; G06Q 30/0211

(57) ABSTRACT

Disclosed herein is a system and method to any two or more MLMs to be merged into a multiline MLM system despite having different commission structures. Each member of the original MLMs is able to maintain their existing downlines without any changes. The system includes a group of simulation modules, which may be accessible by users and executable to simulate the effects of adding a new member under another specific member. This allows users to carefully place sponsored members in their lines such that they can optimize commissions and income, especially when adding multiple new members at the same time.

### CROSS-REFERENCE TO RELATED APPLICATION

The present application is a continuation-in-part and claims the priority benefit of U.S. patent application Ser. No. 17/868,457 filed Jul. 19, 2022, which claims the priority benefit of U.S. provisional application No. 63/223,317 filed Jul. 19, 2021, the disclosures of which are incorporated herein by reference.

### BACKGROUND OF THE INVENTION

### 1. Field of the Disclosure

The present disclosure is generally related to merging multi-level marketing systems.

### 2. Description of the Related Art

MLM companies are defined by a commission structure that is multi-level, such that a commission is payed to at least one member above the member who made a sale or purchase. However, there are multiple kinds of commission structures (e.g., binary, matrix, or unilevel). The problem is that merging these companies while maintaining the integrity of the existing commission tree has been unsuccessful when the two companies do not have the same kind of commission structure. Usually when companies with a different commission structure do merge, the two commission trees are simply kept separate and retain their traits and commission rates. Therefore, members of a binary commission structure are typically compelled to continue to build that structure even if other members of the now merged company are Unilevel. If the merged company does decide to attempt to merge the commission trees, it often ends with members feeling disoriented by changes in position and can bring sudden changes in what was steady income which is very upsetting to members when the change results in a loss of income.

Adding new members to a merged MLM may not be intuitive for members who are used to their original commission structures. It may be hard to estimate the change in commissions that each new member may bring based on which line they are placed in, or even if they should be placed at the top of a new line. Even veteran MLM members may have difficulty because they are only familiar with their original MLM's commission plan.

There is a need for existing MLM companies to merge without having to either continue to keep the companies separate or upset members by rearranging the existing commission structures.

### SUMMARY OF THE CLAIMED INVENTION

Embodiments of the present invention include systems and methods for merging two or more MLMs into a multiline MLM system despite having different commission structures. Each member of the original MLMs is able to maintain their existing downlines without any changes. The system includes a group of simulation modules, which may be accessible by users and executable to simulate the effects of adding a new member under another specific member. This allows users to carefully place sponsored members in their lines such that they can optimize commissions and income, especially when adding multiple new members at the same time.

### BRIEF DESCRIPTIONS OF THE DRAWINGS

FIG. 1 illustrates an exemplary network environment in which a multi-level marketing merger system may be implemented.

FIG. 2A illustrates an exemplary multiline MLM multiline user database.

FIG. 2B illustrates an exemplary multiline MLM commission structure.

FIG. 3 illustrates an exemplary multiline MLM sales database.

FIG. 4 illustrates an exemplary multiline MLM commission module.

FIG. 5 illustrates an exemplary multiline MLM commission rules database.

FIG. 6 illustrates an exemplary multiline MLM commission database.

FIG. 7 illustrates an exemplary multiline MLM additional line module.

FIG. 8 illustrates an exemplary multiline MLM merger module.

FIG. 9 illustrates an exemplary unilevel MLM unilevel base module.

FIG. 10A illustrates an exemplary unilevel MLM unilevel user database.

FIG. 10B illustrates an exemplary unilevel MLM commission structure.

FIG. 11 illustrates an exemplary matrix MLM matrix base module.

FIG. 12A illustrates an exemplary matrix MLM matrix user database.

FIG. 12B illustrates an exemplary matrix MLM commission structure.

FIG. 13 illustrates an exemplary binary MLM binary base module.

FIG. 14A illustrates an exemplary binary MLM binary user database.

FIG. 14B illustrates an exemplary binary MLM commission structure.

FIG. 15 illustrates an exemplary merged MLM user data collection module.

FIG. 16A illustrates an exemplary merged MLM merged user database.

FIG. 16B illustrates an exemplary merged MLM commission structure.

FIG. 17 illustrates an exemplary merged MLM user specific data module.

FIG. 18 illustrates an exemplary user device user base module.

FIG. 19 illustrates an exemplary user device personal user database.

FIG. 20 illustrates an exemplary user device simulated sponsor module.

FIG. 21 illustrates an exemplary user device simulated sales database.

FIG. 22 illustrates an exemplary user device expected commission module.

FIG. 23 illustrates an exemplary user device merged com. rules database.

### DETAILED DESCRIPTION

Embodiments of the present invention include systems and methods for merging two or more MLMs into a multiline MLM system despite having different commission structures. Each member of the original MLMs is able to maintain their existing downlines without any changes. The system includes a group of simulation modules, which may be accessible by users and executable to simulate the effects of adding a new member under another specific member. This allows users to carefully place sponsored members in their lines such that they can optimize commissions and income, especially when adding multiple new members at the same time.

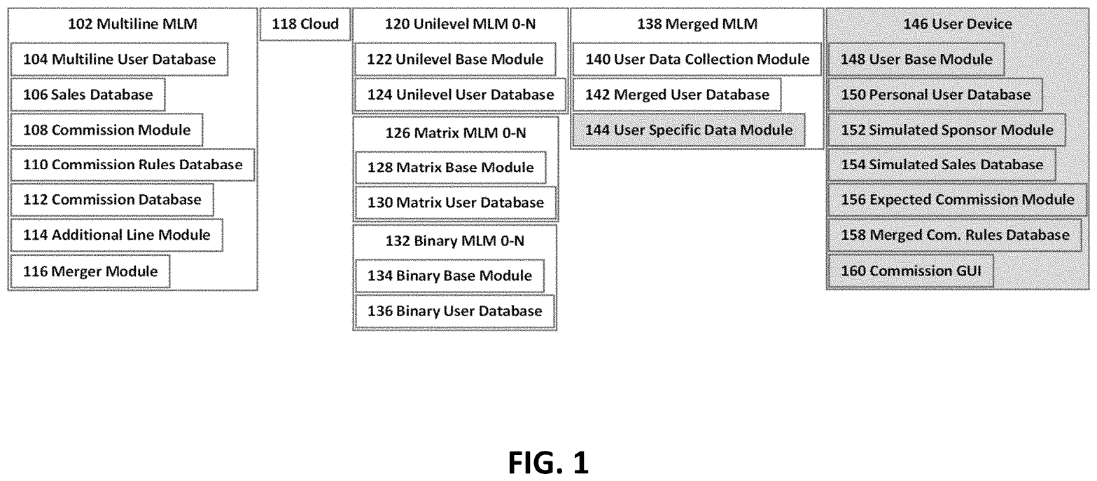

FIG. 1 illustrates an exemplary network environment in which a multi-level marketing merger system may be implemented. The network environment may include a multiline MLM 102, which is a data structure corresponding to a distribution organization characterized by a multi-level payment structure where each user of the organization is a distributor and pays commission to the user or users above them in the organization's structure, and which allows users to potentially have an infinite number of lines corresponding to users below them paying commission, and the users below those users, and so on. In an embodiment, these additional lines may only be added once the users' initial lines meet a threshold volume or commission amount.

A multiline MLM multiline user database 104 may include information on user's position in the multiline MLM 102 commission structure, who enrolled or sponsored the user in the multiline MLM 102, and how many lines the user is currently allowed.

A multiline MLM sales database 106 includes data on sales made by users, which is used by the multiline MLM commission module 108 to pay commissions to other users.

A multiline MLM commission module 108 calculates commission based on new sales data in the multiline MLM sales database 106 and stores that commission in the multiline MLM commission database 112. In some embodiments, the multiline MLM commission module 108 may also pay users directly.

A multiline MLM commission rules database 110 stores commission rules, which are used by the multiline MLM commission module 108 to determine commissions.

A multiline MLM commission database 112 stores commissions calculated by the multiline MLM commission module 108, which are then used by the multiline MLM additional line module 114 to determine if the user qualifies for an additional line. In some embodiments, this data may be used by another module to pay commissions to users.

A multiline MLM additional line module 114 determines if the user has met the threshold commission value on their existing lines based on data from the multiline MLM commission database 112 and if so, adds an additional line to the number of lines that user is allowed.

A multiline MLM merger module 116 receives data from the unilevel MLM unilevel user database 124 via the unilevel MLM unilevel base module 122, MLM matrix user database 130 via the matrix MLM matrix base module 128, and binary MLM binary user database 136 via the binary MLM binary base module 134, makes sure the data includes the relevant metrics, and sends the data to the merged MLM user data collection module 140.

The cloud or communication network 118 may be a wired and/or a wireless network. The communication network 118, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network 118 may allow ubiquitous access to shared pools of configurable system resources and higher-level services that can be rapidly provisioned with minimal management effort, often over Internet and relies on sharing of resources to achieve coherence and economies of scale, like a public utility, while third-party clouds enable organizations to focus on their core businesses instead of expending resources on computer infrastructure and maintenance.

A number of unilevel MLMs 120 may be data structures corresponding to distribution organizations characterized by a multi-level payment structure where each user of the organization is a distributor and pays commission to the user or users above them in the organization's structure, and which allows users to potentially have an infinite amount of lines corresponding to users below them paying commission, and the users below those users, etc., until a certain depth of users is reached. For example, if user 1 is above user 2, who is above user 3, who is above user 4, who is above user 5, etc., then users 2,3, and 4 may pay commissions to user 1, but users 5, 6, 7, etc. do not pay commissions to user 1.

A unilevel MLM unilevel base module 122 extracts data from the unilevel MLM unilevel user database 124 and sends that data to the multiline MLM merger module 116 to be stored in the multiline MLM multiline user database 104.

A unilevel MLM unilevel user database 124 includes information on user's position in the unilevel MLM 120 commission structure, who enrolled or sponsored the user in the unilevel MLM 120, and how many lines the user currently has.

A number of matrix MLMs 126 may be data structures corresponding to distribution organizations characterized by a multi-level payment structure where each user of the organization is a distributor and pays commission to the user or users above them in the organization's structure, and which allows users to have an fixed amount of lines corresponding to users below them paying commission, and the users below those users, etc., until a certain depth of users is reached. For example if user 1 is above user 2, who is above user 3, who is above user 4, who is above user 5, etc., then users 2,3, and 4 may pay commissions to user 1, but users 5, 6, 7, etc. do not pay commissions to user 1; and user 1 may only have a limited number of users directly below them (e.g., 5).

A matrix MLM matrix base module 128 extracts data from the matrix MLM matrix user database 130 and sends that data to the multiline MLM merger module 116 to be stored in the multiline MLM multiline user database 104.

A matrix MLM matrix user database 130 includes information on user's position in the matrix MLM 126 commission structure, who enrolled or sponsored the user in the matrix MLM 126, and how many lines the user currently has.

A number of binary MLMs 132 may be data structures corresponding to distribution organizations characterized by a multi-level payment structure where each user of the organization is a distributor and pays commission to the user or users above them in the organization's structure, and which allows users to have only 2 lines corresponding to users below them paying commission, and the users below those users, etc., for an unlimited amount of depth.

A binary MLM binary base module 134 extracts data from the binary MLM binary user database 136 and sends that data to the multiline MLM merger module 116 to be stored in the multiline MLM multiline user database 104.

A binary MLM binary user database 136 includes information on user's position in the binary MLM 132 commission structure, who enrolled or sponsored the user in the binary MLM 132.

A merged MLM 138 may be a data structure corresponding to a new entity created from the merger of at least two MLMs with different structures, e.g., the merger of a unilevel MLM 120 and a binary MLM 132; a unilevel MLM 120, matrix MLM 126, and binary MLM 132; or 15 matrix MLMs 126 and one binary MLM 132. The merged MLM 138 receives data from the multiline MLM 102 in order to create an organizational structure that includes the members of the MLMs that have been merged. In some embodiments, the merged MLM 138 may not exist at the same time as some of the other components of this system, in which case the data on users may be temporarily or permanently stored in a database by the multiline MLM 102. In some embodiments, the merged MLM 138 may be the same legal entity as one of the MLMs being merged. For example, a binary MLM 132 may acquire a unilevel MLM 120 and convert to a multiline structure in order to absorb the members of the unilevel MLM 120, in which case the binary MLM 132 and merged MLM 138 are the same company or organization from a legal perspective.

A merged MLM user data collection module 140 receives user data from the multiline MLM merger module 116, which is then stored in the merged MLM merged user database 142 and includes data on users from the other MLMs that were merged to create the merged MLM 138.

A merged MLM merged user database 142 includes information on user's position in the merged MLM 138 commission structure, who enrolled or sponsored the user in the merged MLM 138 or one of the MLMs that was eventually merged into the merged MLM 138, and the number of lines that user is allowed under a multiline commission structure.

A merged MLM user specific data module 144 receives a request for information and a user ID from the user device user base module 148, extracts data for that user ID and all user IDs below them in the commission tree from the merged MLM merged user database 142, and sends the information back to the user device user base module 148 to be stored in the user device personal user database 150.

A user device 146 may be inclusive of computing devices such as a laptop, smartphone, table, computer, or smart speaker.

A user device user base module 148 requests user specific data from the merged MLM user specific data module 144, and stores the returned data in the user device personal user database 150, then executes the user device simulated sponsor module 152.

A user device personal user database 150 includes information on a user's position in the merged MLM 138 commission structure, who enrolled or sponsored the user in the merged MLM 138 or one of the MLMs that was eventually merged into the merged MLM 138, and the number of lines that user is allowed under a multiline commission structure. The database may include entries for the user of the user device 146 and all users that are in that user's lines. In some embodiments, the database may include entries for users above the user of the user device 146 or users that are cross-line.

A user device simulated sponsor module 152 allows the user to simulate adding a new member to one of their existing lines. In such a simulation, the data on the new member is added to the user device personal user database 150 and can be later undone so that multiple simulations can be run.

A user device simulated sales database 154 includes simulated future sales that may be used by the user device expected commission module 156 to simulate commissions being paid up the commission tree where at least one sale should be attributed to a new member. In an embodiment, the user device simulated sales database 154 may only include sales attributed to a new member.

A user device expected commission module 156 simulates commissions being paid to users so that the user of the user device 146 can see the direct effects on commission that a new member may have based on their position in the commission tree.

A user device merged commission rules database 158 stores the commission rules of the merged MLM 138, which are used by the user device expected commission module 156 to determine expected commissions.

A user device commission GUI 160 displays the expected commissions from the user device expected commission module 156, so that the user of the user device 146 can visualize how commissions are affected by the placement of the new member.

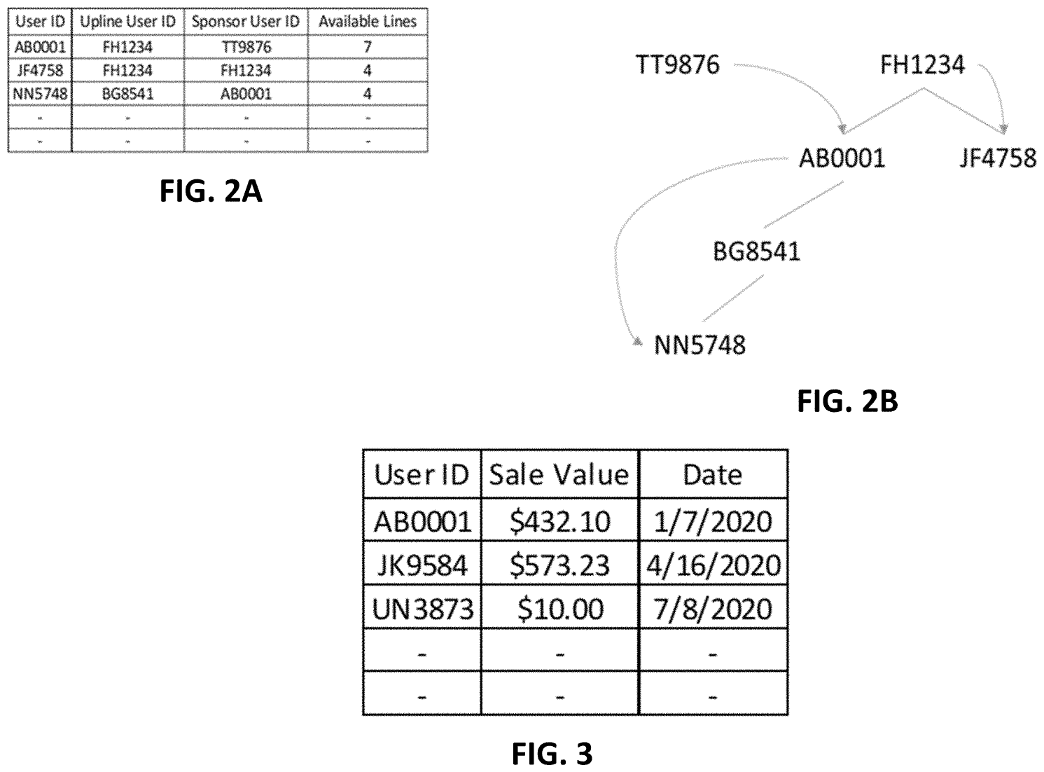

FIG. 2A illustrates an exemplary multiline MLM multiline user database 104, and FIG. 2B illustrates an exemplary multiline MLM commission structure. The multiline MLM multiline user database 104 includes a user ID (e.g., AB0001), information on user's position in the multiline MLM 102 commission structure, the user ID of the user above them in the commission structure (e.g., FH1234), who enrolled or sponsored the user in the multiline MLM 102 (e.g., user ID TT9876), and how many lines the user is currently allowed (e.g., 7). Users are assigned a default number of lines when they join the multiline MLM 102, such as users that were merged from another MLM. The unilevel MLM 120 may come into the multiline MLM 102 with at least the number of lines they had under their old MLM structure. In an embodiment, the default number of lines is 4.

FIG. 2B illustrates an exemplary multiline MLM commission structure based on the data in FIG. 2A, in which the straight lines indicate an upline/downline relationship between two users and a curved, arrowed line indicates that the user the arrow points to was sponsored by the user the line originates from, more lines and users may exist than are shown.

FIG. 3 illustrates an exemplary multiline MLM sales database 106. The multiline MLM sales database 106 includes data on sales made by users, which includes a user ID (e.g., AB0001), a sale value (e.g., $432.10), and a transaction date (e.g., Jan. 7, 2020), which is used by the multiline MLM commission module 108 to pay commissions to other users. In some embodiments, the database may include more sales data such as the seller's ID if applicable, item IDs of the items sold, volume sold, payment method and data, etc.

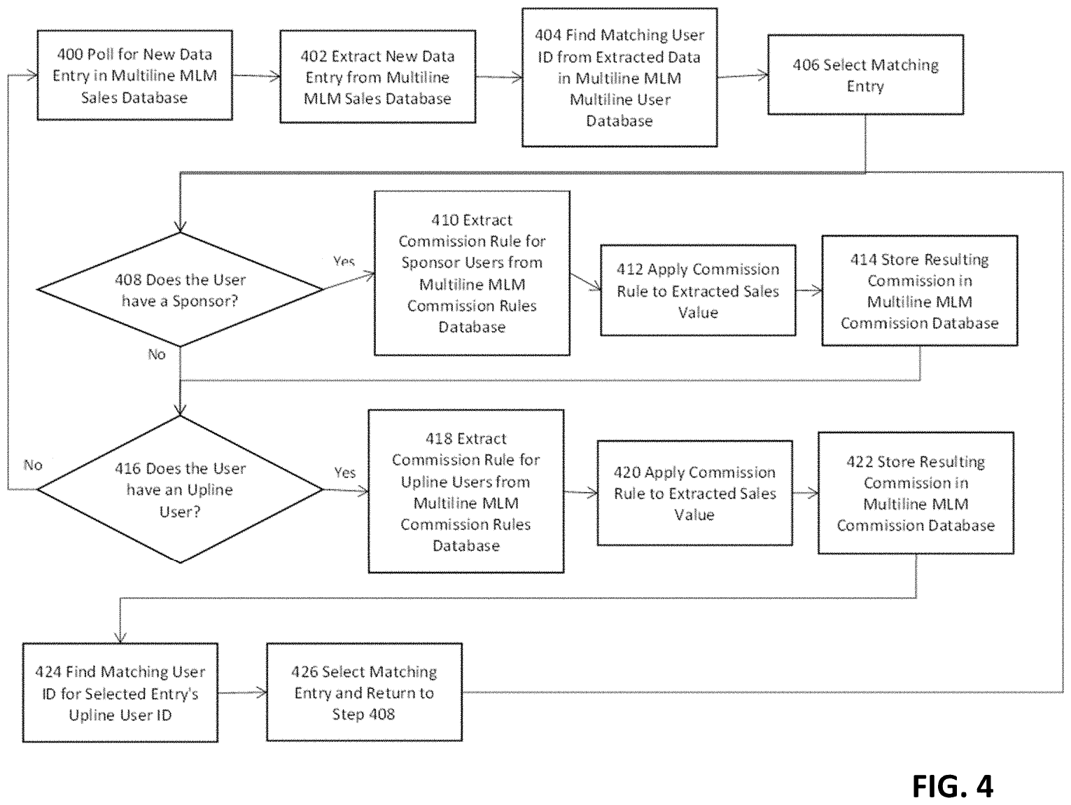

FIG. 4 illustrates an exemplary multiline MLM commission module 108. The process begins with the multiline MLM commission module 108 polling for a new data entry in the multiline MLM sales database 106, for example, when a sale is made by a user at step 400.

The multiline MLM commission module 108 extracts the new data entry from the multiline MLM sales database 106, which includes at least a user ID, sales value, and date at step 402.

At step 404, the multiline MLM commission module 108 searches for a User ID in the multiline MLM multiline user database 104 that matches the user ID extracted from the multiline MLM sales database 106. For example, if the extracted user ID had a value of “AB0001,” then the multiline MLM commission module 108 may search the multiline MLM multiline user database 104 for a value of “AB0001” in the “User ID” category.

The multiline MLM commission module 108 selects the entry in the multiline MLM multiline user database 104 with a matching user ID value at step 406.

At step 408, the multiline MLM commission module 108 determines if the user has a sponsor by checking the entry for a value in the “Sponsor User ID” category. If there is no value or the value does not correspond to a user ID, then the multiline MLM commission module 108 may skip to step 416.

If there is a value that corresponds to a user ID in the “Sponsor User ID” category, the multiline MLM commission module 108 extracts the commission rule from the multiline MLM commission rule database 110 for sponsor users at step 410.

At step 412, the multiline MLM commission module 108 applies the extracted commission rule to the sales value extracted from the multiline MLM sales database 106. For example, if the rule is 10% commission for sponsors and the sales value is $300, then $300 may be multiplied by 10% to get $30, which is the commission payable to the sponsor. In an embodiment, the sponsor may be paid directly by the multiline MLM commission module 108 after this step.

At step 414, the multiline MLM commission module 108 stores the resulting commission in the multiline MLM commission database 112, along with the user ID of the sponsoring user to be paid, the user ID of the sponsored user, the commission type (e.g., sponsor), and the date extracted from the multiline MLM sales database 106. In some embodiments, the date may be changed to reflect a delay in the processing of the commission or payment of the commission.

At step 416, the multiline MLM commission module 108 determines if the user has an upline user by checking the entry for a value in the “Upline User ID” category. If there is no value or the value does not correspond to a user ID, then the multiline MLM commission module 108 may return to polling for a new data entry in the multiline MLM sales database 106.

If there is a value that corresponds to a user ID in the “Upline User ID” category, the multiline MLM commission module 108 extracts the commission rule from the multiline MLM commission rule database 110 for upline users at step 418.

At step 420, the multiline MLM commission module 108 applies the extracted commission rule to the sales value extracted from the multiline MLM sales database 106. For example, if the rule is 10% commission for upline users and the sales value is $300, then $300 may be multiplied by 10% to get $30, which is the commission payable to the upline user. In some embodiments, users may receive a different commission based on how many levels upline they are from the user who made the sale. For example, the upline user of the upline user may earn 5% commission, and next upline user may earn 1% commission. In an embodiment, the upline user may be paid directly by the multiline MLM commission module 108 after this step.

At step 422, the multiline MLM commission module 108 stores the resulting commission in the multiline MLM commission database 112, along with the user ID of the upline user to be paid, the user ID of the downline user, the commission type (e.g., upline), and the date extracted from the multiline MLM sales database 106. In some embodiments, the date may be changed to reflect a delay in the processing of the commission or payment of the commission.

The multiline MLM commission module 108 then searches the multiline MLM multiline user database 104 for an entry where the user ID in the “User ID” category matches the user ID in the “Upline User ID” category of the currently selected entry at step 424.

The multiline MLM commission module 108 selects the entry with the matching user ID value as the new selected entry and returns to step 408 at step 426.

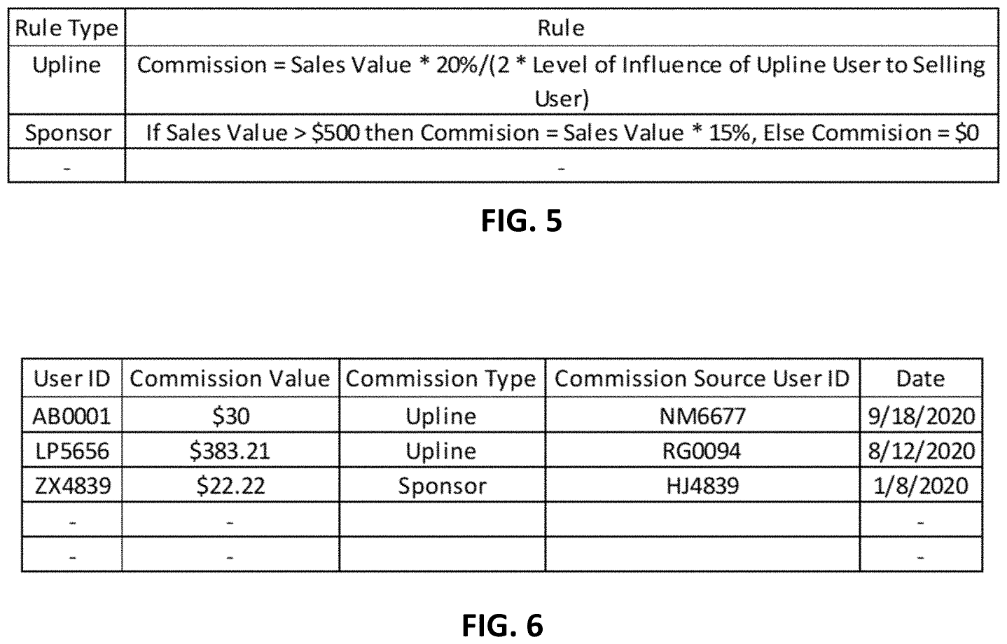

FIG. 5 illustrates an exemplary multiline MLM commission rules database 110. The multiline MLM commission rules database 110 includes commission rules, which are used by the multiline MLM commission module 108 to determine commissions. Commission rules can be complex or simple, but may often involve a mathematical calculation. For example, a rule may dictate that commissions for upline users are 10% of the sales value, divided by two for each level above the selling user, meaning that for a $100 dollar sale the upline user may receive $10 the user above them, or 2nd level of influence from the user who made the sale, may receive $5; the user above them may receive $2.50, etc. In another example, the rule may dictate that the commission for sponsors is 15% of the sale, but only if the sale is over $500; otherwise no commission is paid. The database also includes the type of rule (e.g., “Sponsor”), which indicates that the rule should be used to calculate commissions for sponsors. In some embodiments, multiple rules may exist for one rule type. For example, one rule may apply to sponsors that are also somewhere upline of the user who made the sale, while a different sponsor rule may apply if the sponsor is cross-line, meaning they are not anywhere upline of the user who made the sale.

FIG. 6 illustrates an exemplary multiline MLM commission database 112. The multiline MLM commission database 112 includes commissions calculated by the multiline MLM commission module 108, which are then used by the multiline MLM additional line module 114 to determine if the user qualifies for an additional line. In some embodiments, this data may be used by another module to pay commissions to users, which comprises at least a user ID (e.g., AB0001), a commission value (e.g., $30), the type of commission (e.g., downline), the user ID of the user the commission came from (e.g., NM6677), and a date (e.g., Sep. 18, 2020). If the commission came from a sale made somewhere in a user's downline, then the commission may be considered to come from the immediately downline user. In other embodiments, the commission may be recorded as coming from the selling user.

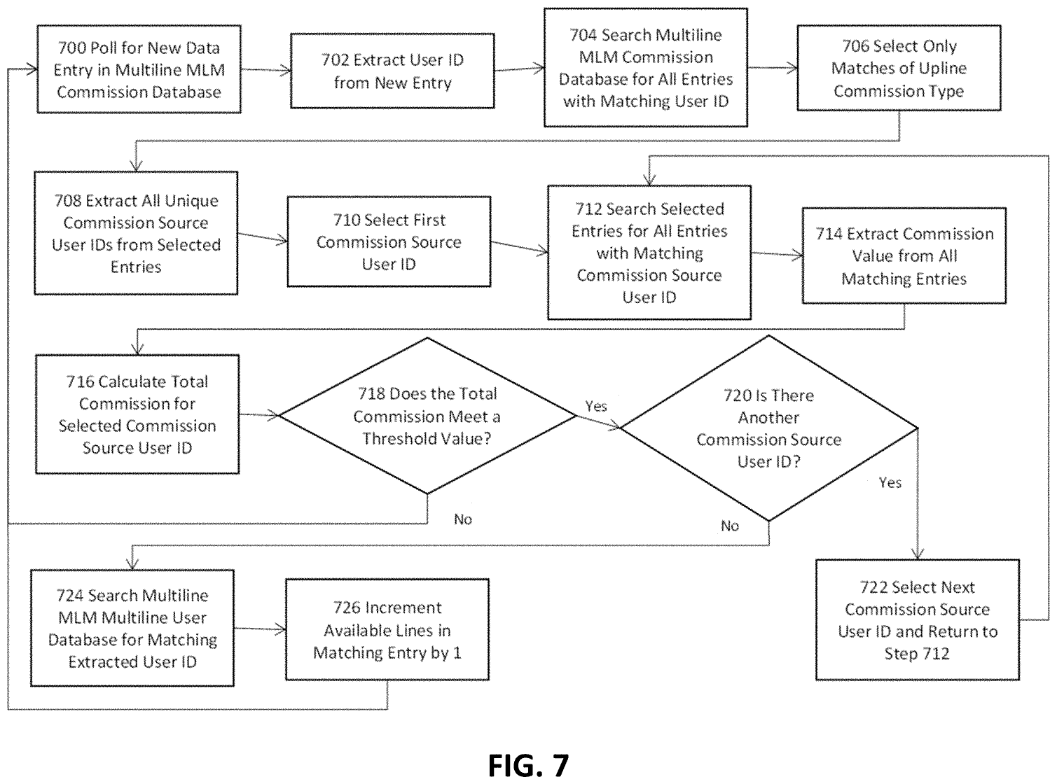

FIG. 7 illustrates an exemplary multiline MLM additional line module 114. The process begins with the multiline MLM additional line module 114 polling for a new data entry in the multiline MLM commission database 112 at step 700.

The multiline MLM additional line module 114 extracts the user ID from the User ID category in the new data entry (e.g., AB0001) at step 702.

The multiline MLM additional line module 114 searches the multiline MLM commission database 112 for all entries that also have the extracted user ID in the User ID category, which is data on all the commissions that have been paid to that user, at step 704.

The multiline MLM additional line module 114 selects all the matching entries that also have “upline” in the Commission Type category at step 706.

At step 708, the multiline MLM additional line module 114 extracts all the user IDs in the Commission Source User ID category of the entries, while ignoring repeats. Each of these user IDs corresponds to a user that is directly downline of the user whose user ID was extracted from the new data entry, and therefore each correspond to a line. In some embodiments, lines that have not yet made sales may be accounted for by creating a null or nominal commission upon creation. For example, if user AB0001 places user CD0002 in their immediate downline, a record may be recorded in the multiline MLM commission database 112 for $0.01 or $0.00. Thus, CD0002 is recognized as the start of one of AB0001's downlines.

At step 710, the multiline MLM additional line module 114 selects the first of the extracted Commission Source User IDs, which may be determined by, for example, alphabetical order or most recent commission.

At step 712, the multiline MLM additional line module 114 searches the entries selected in step 706 for all entries that match the commission source user ID selected in the Commission Source User ID category, which may find all the entries that correspond to commissions made by a single line.

At step 714, the multiline MLM additional line module 114 extracts the commission value in the Commission Value Category for each matching entry. In some embodiments, the commissions are further filtered by a time frame. For example, only commission values from commissions made in the last month may be extracted.

The multiline MLM additional line module 114 totals the extracted commission values by adding them all together to get the total commission from that line at step 716.

At step 718, the multiline MLM additional line module 114 determines if the total commission calculated meets a threshold value, which is a value that all lines meet before a user is allowed to have a new line. For example, if the user has 7 lines, each line has made over $1000 in commission, and the threshold value is $1000, then the user may be allowed to create an 8th line. The threshold value can be fixed or variable. In an embodiment, the threshold value is stored in a database and retrieved by the multiline MLM additional line module 114. If the total commission calculated fails to meet the threshold value, then the user cannot receive a new line, because all lines meet the threshold value and the multiline MLM additional line module 114 may return to polling for a new data entry in the multiline MLM commission database 112.

At step 720, if the total commission calculated meets the threshold value, the multiline MLM additional line module 114 determines if there is another commission source user ID that was extracted in step 708.

If there is another commission source user ID, the multiline MLM additional line module 114 selects the next commission source user ID and returns to step 712 at step 722.

At step 724, if there is not another commission source user ID, the multiline MLM additional line module 114 searches the multiline MLM multiline user database 104 for an entry that matches the user ID extracted from the new entry in step 702 in the User ID category.

At step 726, the multiline MLM additional line module 114 increments the number in the Available Lines category of the matching entry by 1, which allows the user to create one additional line. In some embodiments, the number in the Available Lines category of the matching entry may be changed in another way, for example, increased by 2, multiplied by 1.2 and rounded to the nearest whole number, squared, etc.

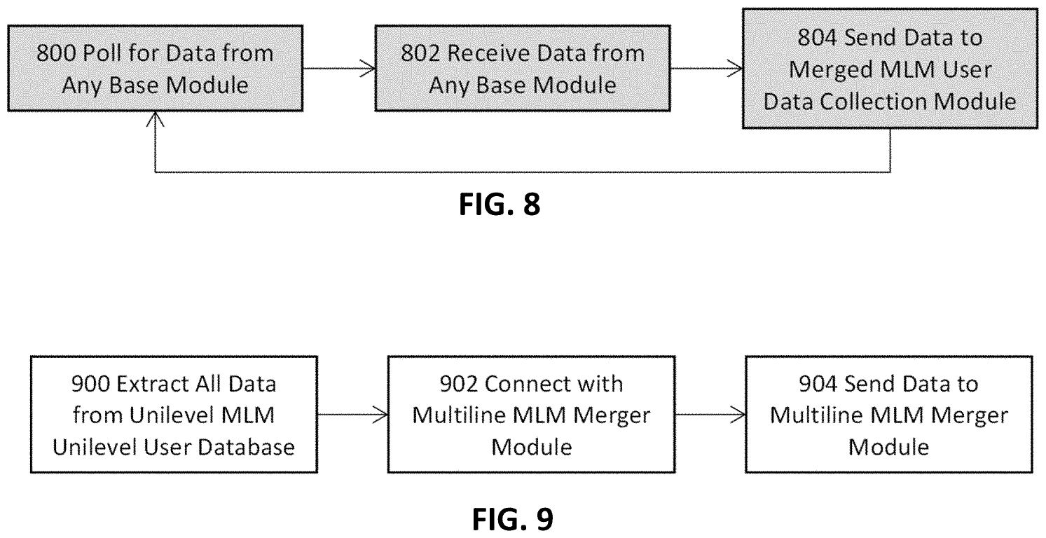

FIG. 8 illustrates an exemplary multiline MLM merger module 116. The process begins with the multiline MLM merger module 116 polling for data from the unilevel MLM unilevel base module 122, matrix MLM matrix base module 128, or binary MLM binary base module 134. This data is extracted by the base module of each type of MLM from the respective database of user data at step 800.

At step 802, the multiline MLM merger module 116 receives data from the unilevel MLM unilevel base module 122, matrix MLM matrix base module 128, or binary MLM binary base module 134, which includes a user ID (e.g., AB0001), information on user's position in the multiline MLM 102 commission structure via the user ID of the user above them in the commission structure (e.g., FH1234), who enrolled or sponsored the user in the multiline MLM 102 (e.g., user ID TT9876), and how many lines the user currently has in the unilevel MLM 120 (e.g., 7). In some embodiments, where the number of lines is restricted then he number of lines may not be included with each user but sent as one value, for example a binary MLM 132 may be assumed to allow 2 lines for each user, and a matrix MLM 126 may have a known maximum number of lines (e.g., 5), which is already accounted for by the system or sent to the multiline MLM merger module 116 alongside the user data.

At step 804, the multiline MLM merger module 116 sends the data to the merged MLM user data collection module 140 to be stored in the merged MLM merged user database 142. In an embodiment, user data without a number of lines may be set to the default value. For example, data from a binary MLM 132 may not include data for the amount of lines, because all members of a binary MLM 132 have 2 available lines, in which case the data may be amended to include the default number of lines that would be assigned to a new member of the merged MLM 138. In an embodiment, if the number of lines a user has is less than the default value it may be set to the default value. In an embodiment, the default value is 4 lines.

FIG. 9 illustrates an exemplary unilevel MLM unilevel base module 122. The process begins with the unilevel MLM unilevel base module 122 extracts all the data stored in the unilevel MLM unilevel user database 124 at step 900.

The unilevel MLM unilevel base module 122 connects with the multiline MLM merger module 116 through the cloud or Internet 118, via a physical connection, or by any other method of transferring data at step 902.

The unilevel MLM unilevel base module 122 sends the data extracted from the unilevel MLM unilevel user database 124 to the multiline MLM merger module 116 at step 904.

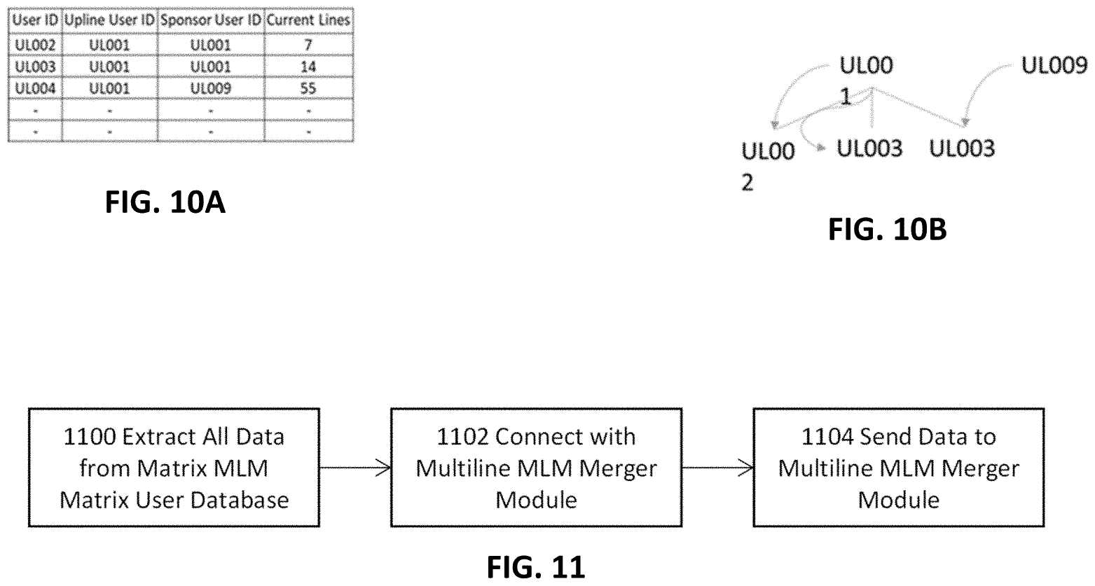

FIG. 10A illustrates an exemplary unilevel MLM unilevel user database 124, and FIG. 10B illustrates an exemplary unilevel MLM commission structure. The unilevel MLM unilevel user database 124 includes information on user's position in the unilevel MLM 120 commission structure, who enrolled or sponsored the user in the unilevel MLM 120, and how many lines the user currently has, which includes a user ID (e.g., UL002), information on user's position in the multiline MLM 102 commission structure, the user ID of the user above them in the commission structure (e.g., UL001), who enrolled or sponsored the user in the multiline MLM 102 (e.g., user ID UL009), and how many lines the user currently has within the existing unilevel MLM 120 (e.g., 7).

FIG. 10B illustrates an exemplary unilevel MLM commission structure based on the data in FIG. 10A, in which the straight lines indicate an upline/downline relationship between two users and a curved, arrowed line indicates that the user the arrow points to was sponsored by the user the line originates from, and the dotted straight line indicates the two users have an indirect upline/downline relationship, meaning there are more users in the line that are not shown, more lines and users may exist than are shown.

FIG. 11 illustrates an exemplary matrix MLM matrix base module 128. The process begins with the matrix MLM matrix base module 128 extracts all the data stored in the matrix MLM matrix user database 130 at step 1100.

The matrix MLM matrix base module 128 connects with the multiline MLM merger module 116 through the cloud or Internet 118, via a physical connection, or by any other method of transferring data at step 1102.

The matrix MLM matrix base module 128 sends the data extracted from the matrix MLM matrix user database 130 to the multiline MLM merger module 116 at step 1104.

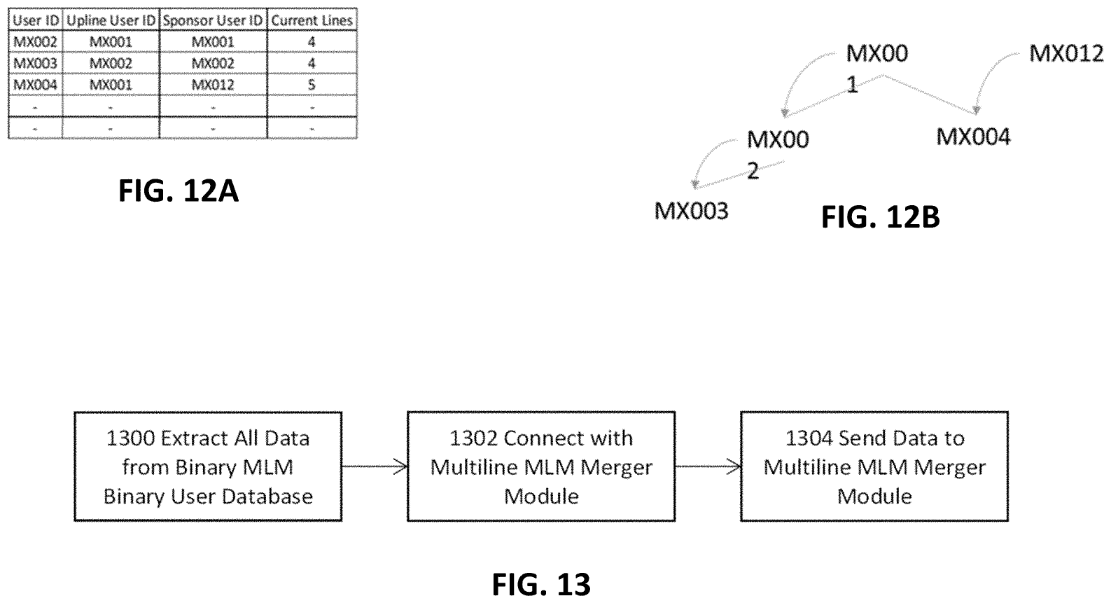

FIG. 12A illustrates an exemplary matrix MLM matrix user database 130, and FIG. 12B illustrates an exemplary matrix MLM commission structure. The matrix MLM matrix user database 130 includes information on user's position in the matrix MLM 126 commission structure, who enrolled or sponsored the user in the matrix MLM 126, and how many lines the user currently has, which includes a user ID (e.g., AB0001), information on user's position in the multiline MLM 102 commission structure, the user ID of the user above them in the commission structure (e.g., FH1234), who enrolled or sponsored the user in the multiline MLM 102 (e.g., user ID TT9876), and how many lines the user currently has within the existing matrix MLM 126 (e.g., 5). In an embodiment, the number of lines a user currently has may not be necessary as all users under a matrix MLM 126 can be assumed to have the maximum allowed for that structure. For example, in a matrix MLM 126 where the maximum amount of lines is 5, all users may be given a default 5 lines after being merged into the multiline MLM 102.

FIG. 12B illustrates an exemplary matrix MLM commission structure based on the data in FIG. 12A, in which the straight lines indicate an upline/downline relationship between two users and a curved, arrowed line indicates that the user the arrow points to was sponsored by the user the line originates from, and the dotted straight line indicates the two users have an indirect upline/downline relationship, meaning there are more users in the line that are not shown, more lines and users may exist than are shown.

FIG. 13 illustrates an exemplary binary MLM binary base module 134. The process begins with the binary MLM binary base module 134 extracts all the data stored in the binary MLM binary user database 136 at step 1300. The binary MLM binary base module 134 connects with the multiline MLM merger module 116 through the cloud or Internet 118, via a physical connection, or by any other method of transferring data at step 1302. The binary MLM binary base module 134 sends the data extracted from the binary MLM binary user database 136 to the multiline MLM merger module 116 at step 1304.

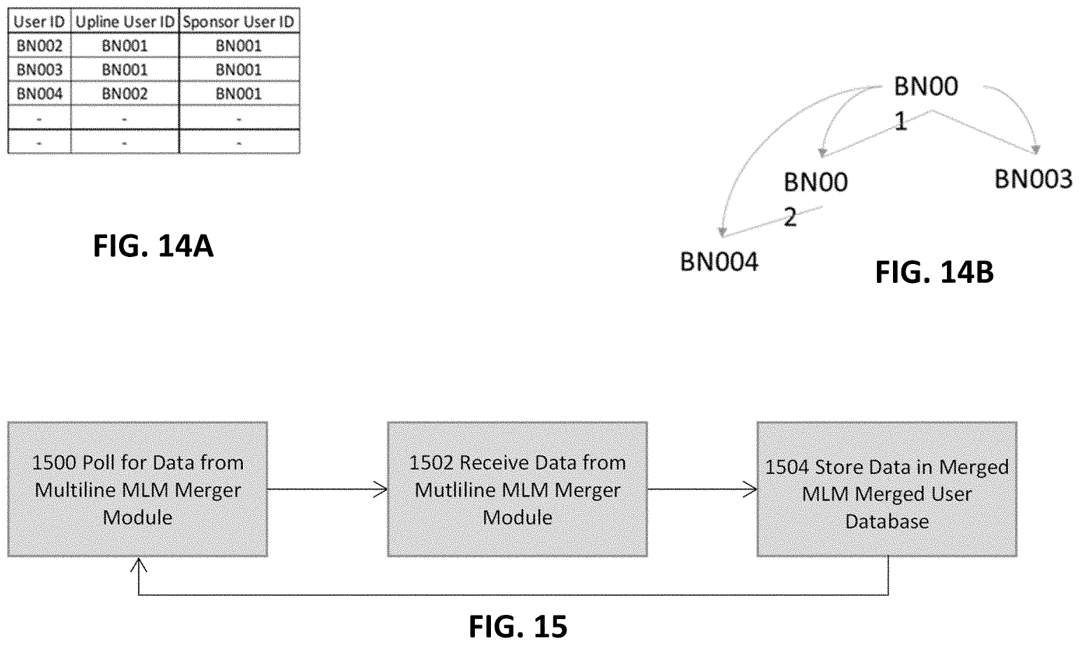

FIG. 14A illustrates an exemplary binary MLM binary user database 136, and FIG. 14B illustrates an exemplary binary MLM commission structure. The binary MLM binary user database 136 includes information on user's position in the binary MLM 132 commission structure, who enrolled or sponsored the user in the binary MLM 132, and how many lines the user currently has, which includes a user ID (e.g., BN002), information on user's position in the multiline MLM 102 commission structure, the user ID of the user above them in the commission structure (e.g., BN0010), who enrolled or sponsored the user in the multiline MLM 102 (e.g., user ID BN0010), and how many lines the user currently has within the existing binary MLM 132 (e.g., 7).

FIG. 14B illustrates an exemplary binary MLM commission structure based on the data in FIG. 14A, in which the straight lines indicate an upline/downline relationship between two users and a curved, arrowed line indicates that the user the arrow points to was sponsored by the user the line originates from, and the dotted straight line indicates the two users have an indirect upline/downline relationship, meaning there are more users in the line that are not shown, more lines and users may exist than are shown.

FIG. 15 illustrates an exemplary merged MLM user data collection module 140. The process begins with the merged MLM user data collection module 140 polling for data from the multiline MLM merger module 116 at step 1500. The merged MLM user data collection module 140 receives data from the multiline MLM merger module 116 at step 1502. The merged MLM user data collection module 140 stores the received data in the merged MLM merged user database 142 at step 1504.

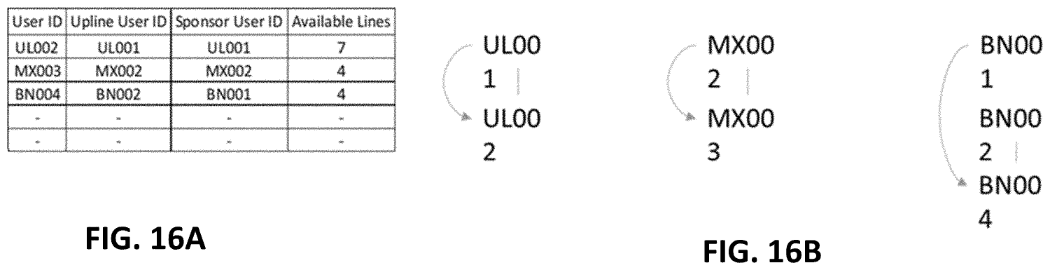

FIG. 16A illustrates an exemplary merged MLM merged user database 142, and FIG. 16B illustrates an exemplary merged MLM commission structure. The merged MLM merged user database 142 includes a user ID (e.g., UL002), information on user's position in the merged MLM 138 commission structure, the user ID of the user above them in the commission structure (e.g., UL001), who enrolled or sponsored the user in the merged MLM 138 or the original MLM that was merged into the merged MLM 138 (e.g., user ID UL001), and how many lines the user is currently allowed (e.g., 7). Users are assigned a default number of lines when they join the merged MLM 138 (e.g., users that were merged from another MLM), and the unilevel MLM 120 may come into the merged MLM 138 with at least the number of lines they had under their old MLM structure. In an embodiment, the default number of lines is 4.

FIG. 16B illustrates an exemplary merged MLM commission structure based on the data in FIG. 16A, in which the straight lines indicate an upline/downline relationship between two users and a curved, arrowed line indicates that the user the arrow points to was sponsored by the user the line originates from, more lines and users may exist than are shown.

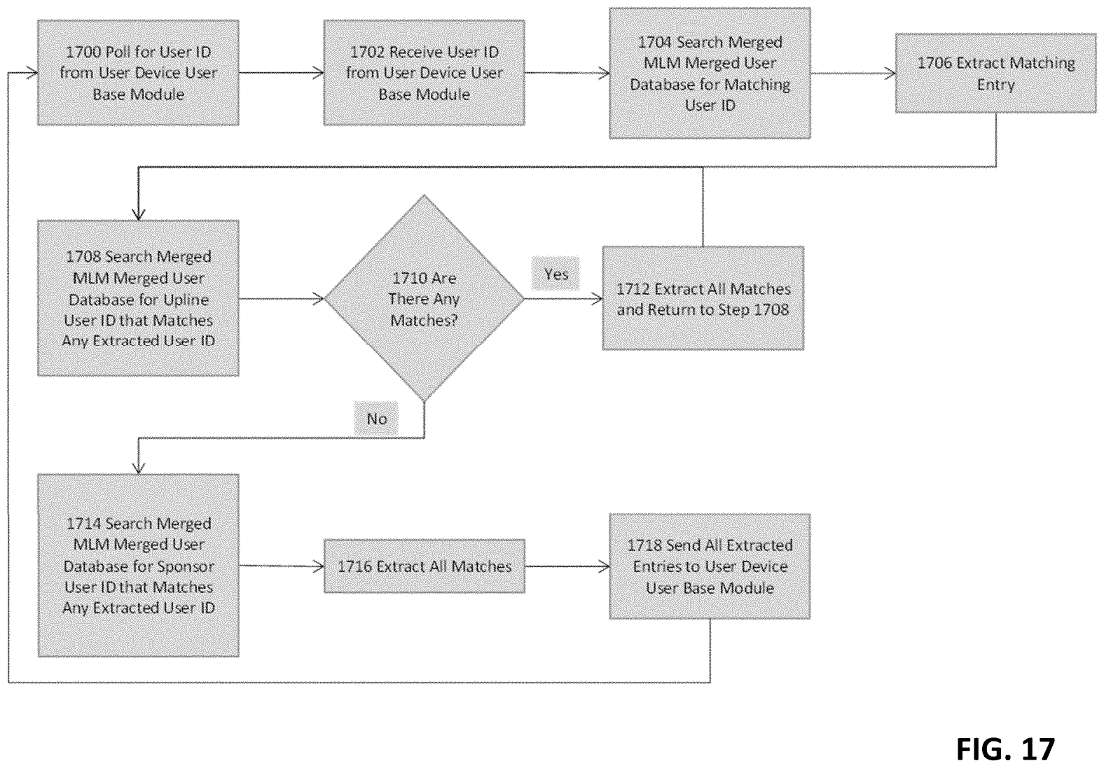

FIG. 17 illustrates an exemplary merged MLM user specific data module 144. The process begins with the merged MLM user specific data module 144 polling for a user ID and a request for data from the user device user base module 148 at step 1700.

The merged MLM user specific data module 144 receives the user ID and request for data from the user device user base module 148 at step 1702.

The merged MLM user specific data module 144 searches the merged MLM merged user database 142 for an entry with a user ID in the “User ID” category that matches the received user ID at step 1704.

The merged MLM user specific data module 144 extracts the matching entry in the merged MLM merged user database 142 at step 1706.

The merged MLM user specific data module 144 searches the merged MLM merged user database 142 for an entry with a user ID in the “Upline User ID” category that matches the any user ID in the “User ID” Category of any extracted entry at step 1708.

The merged MLM user specific data module 144 determines if there are any matches in the merged MLM merged user database 142 at step 1710.

If there is at least one match in the merged MLM merged user database 142, the merged MLM user specific data module 144 extracts the matching entries and returns to step 1708 at step 1712.

If there are no matches in the merged MLM merged user database 142, the merged MLM user specific data module 144 searches the merged MLM merged user database 142 for an entry with a user ID in the “Sponsor User ID” category that matches the any user ID in the “User ID” Category of any extracted entry at step 1714.

The merged MLM user specific data module 144 extracts the matching entries in the merged MLM merged user database 142 at step 1716.

The merged MLM user specific data module 144 sends all extracted entries to the user device user base module 148 and returns to polling for a user ID and request for data at step 1718.

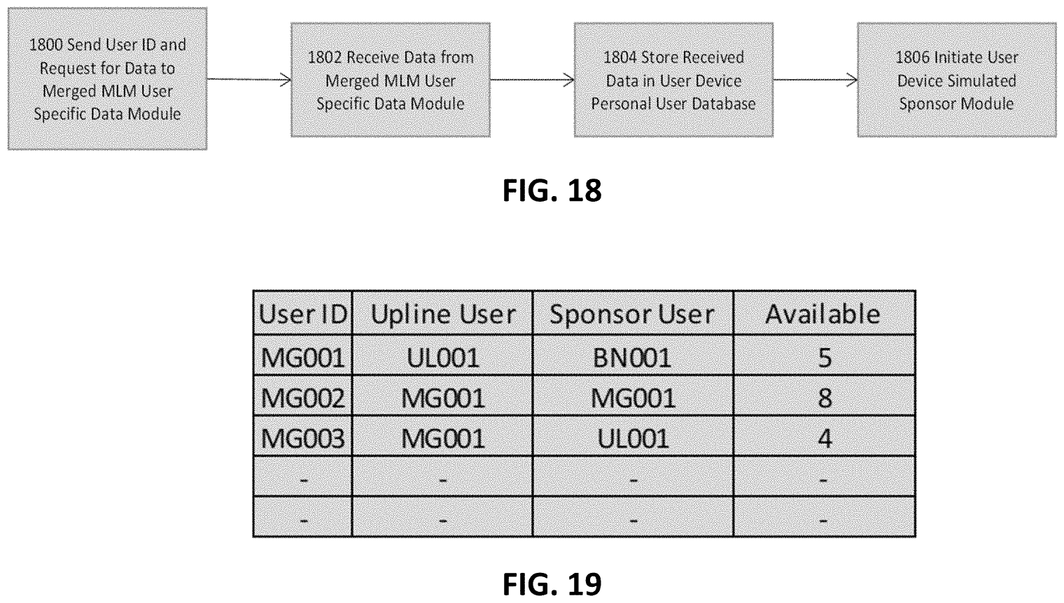

FIG. 18 illustrates an exemplary user device user base module 148. The process begins with the user device user base module 148 sends the user ID of the user of the user device 146 to the merged MLM user specific data module 144 and request data specific to that user from the merged MLM merged user database 142, which includes at least the data entries of the user of the user device 146 and any other entries that can contribute to that user's commissions or income at step 1800.

The user device user base module 148 receives the requested data from the merged MLM user specific data module 144 at step 1802.

The user device user base module 148 stores the received data in the user device personal user database 150, if there is already data in the database it may be edited or overwritten at step 1804.

The user device user base module 148 executes the user device simulated sponsor module 152 at step 1806.

FIG. 19 illustrates an exemplary user device personal user database 150. The user device personal user database 150 includes data entries for the user of the user device 146 and all users that are in that user's lines, sponsored by that user, or would otherwise pay commission to that user, the entries comprising a user ID (e.g., MG001), information on user's position in the merged MLM 138 commission structure, the user ID of the user above them in the commission structure (e.g., UL001), who enrolled or sponsored the user in the merged MLM 138 or the original MLM that was merged into the merged MLM 138 (e.g., user ID BN001), and how many lines the user is currently allowed (e.g., 5).

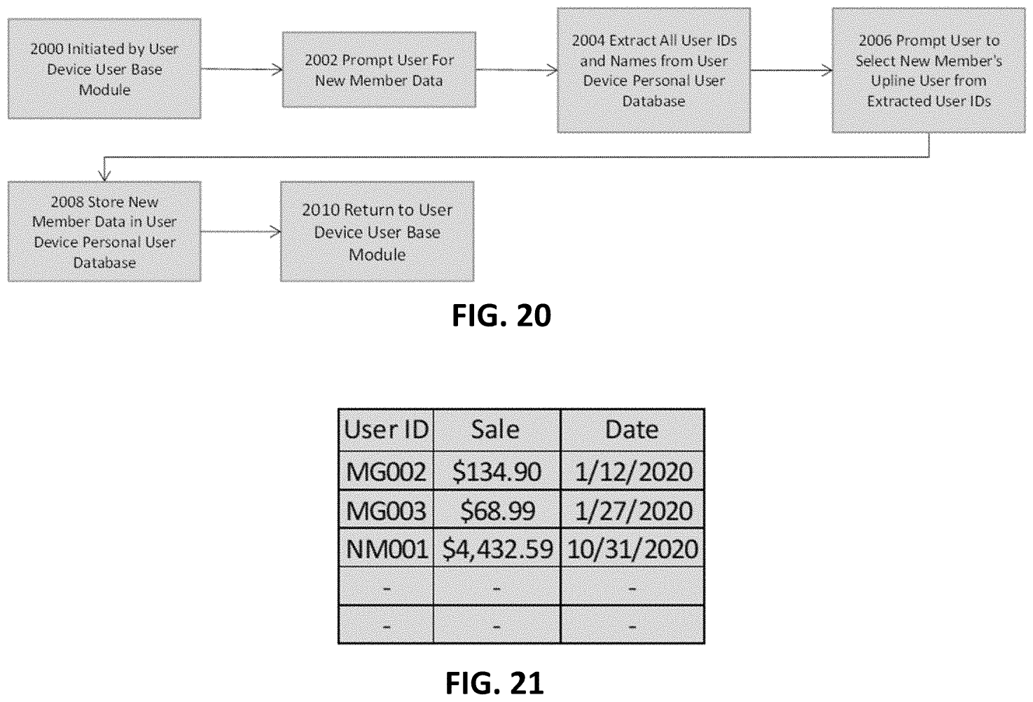

FIG. 20 illustrates an exemplary user device simulated sponsor module 152. The process begins with the user device simulated sponsor module 152 being executed by the user device user base module 148 at step 2000.

At step 2002, the user device simulated sponsor module 152 prompts the user for new member data which includes a name and address. In some embodiments, name and address may be optional. In some embodiments, more than name and address may be required.

The user device simulated sponsor module 152 extracts user IDs and Names from all entries in the user device personal user database 150 at step 2004.

At step 2006, the user device simulated sponsor module 152 prompts the user to select the new member's upline user by selecting another user's name. In an embodiment, this step may be facilitated by a GUI, for example, a list of names with a checkmark box next to each. The user device simulated sponsor module 152 stores the new member data in the user device personal user database 150 as a new entry. The new member is given a unique user ID (e.g., “NM001”), the upline user ID corresponding to the name chosen and a sponsor user ID that is the user ID of the user of the user device 146.

In an embodiment, the entry is marked as temporary or simulated and deleted after an amount of time has passed or deleted by another module at step 2008.

The user device simulated sponsor module 152 returns to the user device user base module 148 at step 2010.

FIG. 21 illustrates an exemplary user device simulated sales database 154. The user device simulated sales database 154 includes example data on sales made by users, which includes a user ID (e.g., MG002), a sale value (e.g., $134.90), and a transaction date (e.g., Jan. 12, 2020), which is used by the user device expected commission module 156 to simulate commissions to be paid. In some embodiments, the database may include more sales data such as the seller's ID if applicable, item IDs of the items sold, volume sold, payment method and data, etc., and may include sales data from before the merger if the data is available. The database may include automatically generated example sales data and data that is manually entered by the user of the user device 146, or both.

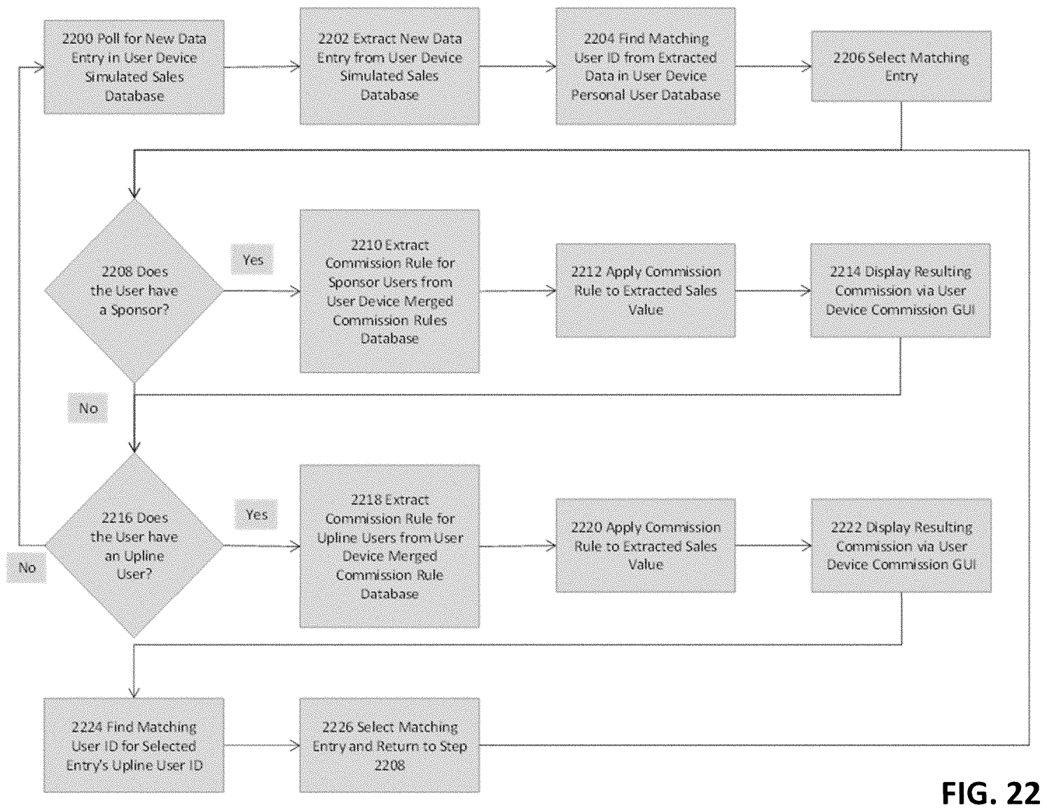

FIG. 22 illustrates an exemplary user device expected commission module 156. The process begins with the user device expected commission module 156 polling for a new data entry in the user device simulated sales database 154 at step 2200.

The user device expected commission module 156 extracts the new data entry from the user device simulated sales database 154 which includes at least a user ID, sales value, and date at step 2202.

At step 2204, the user device expected commission module 156 searches for a User ID in the user device personal user database 150 that matches the user ID extracted from the user device simulated sales database 154. For example, if the extracted user ID had a value of “UL002,” then the user device expected commission module 156 may search the user device personal user database 150 for a value of “UL002” in the “User ID” category.

The user device expected commission module 156 selects the entry in the user device personal user database 150 with a matching user ID value at step 2206.

At step 2208, the user device expected commission module 156 determines if the user has a sponsor by checking the entry for a value in the “Sponsor User ID” category. If there is no value or the value does not correspond to a user ID, then the user device expected commission module 156 may skip to step 2016.

If there is a value that corresponds to a user ID in the “Sponsor User ID” category, the user device expected commission module 156 extracts the commission rule from the user device merged commission rules database 158 for sponsor users at step 2210.

At step 2212, the user device expected commission module 156 applies the extracted commission rule to the sales value extracted from the user device simulated sales database 154, for example if the rule is 10% commission for sponsors and the sales value is $300, then $300 may be multiplied by 10% to get $30 which is the commission payable to the sponsor.

At step 2214, the user device expected commission module 156 displays the resulting commission via the user device commission GUI 160, along with the user ID of the sponsoring user to be paid, the user ID of the sponsored user, the commission type (e.g., sponsor), and the date extracted from the user device simulated sales database 154. In an embodiment, only commissions that affect the income of the user of the user device 146 may be displayed.

At step 2216, the user device expected commission module 156 determines if the user has an upline user by checking the entry for a value in the “Upline User ID” category. If there is no value or the value does not correspond to a user ID, then the user device expected commission module 156 may return to polling for a new data entry in the user device simulated sales database 154.

If there is a value that corresponds to a user ID in the “Upline User ID” category, the user device expected commission module 156 extracts the commission rule from the user device merged commission rules database 158 for upline users at step 2218.

At step 2220, the user device expected commission module 156 applies the extracted commission rule to the sales value extracted from the user device simulated sales database 154. For example, if the rule is 10% commission for upline users and the sales value is $300, then $300 may be multiplied by 10% to get $30, which is the commission payable to the upline user. In some embodiments, users may receive a different commission based on how many levels upline they are from the user who made the sale. For example, the upline user of the upline user may earn 5% commission, and next upline user may earn 1% commission.

At step 2222, the user device expected commission module 156 displays the resulting commission via the user device commission GUI 160 along with the user ID of the sponsoring user to be paid, the user ID of the sponsored user, the commission type, in this case sponsor, and the date extracted from the user device simulated sales database 154. In an embodiment, only commissions that affect the income of the user of the user device 146 may be displayed at step 2222.

The user device expected commission module 156 then searches the merged MLM multiline user database 142 for an entry where the user ID in the “User ID” category matches the user ID in the “Upline User ID” category of the currently selected entry at step 2224.

The user device expected commission module 156 selects the entry with the matching user ID value as the new selected entry and returns to step 2208 at step 2226.

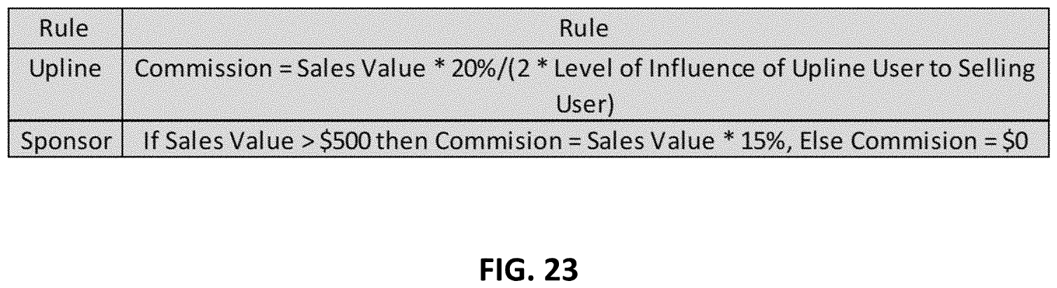

FIG. 23 illustrates an exemplary user device merged com. rules database 158. \ The user device merged commission rules database 158 includes commission rules which are used by the user device expected commission module 156 to determine commissions. Commission rules can be complex or simple, but may often involve a mathematical calculation. For example, a rule may dictate that commissions for upline users are 10% of the sales value, divided by two for each level above the selling user, meaning that for a $100 dollar sale the upline user may receive $10 the user above them, or 2nd level of influence from the user who made the sale, may receive $5, the user above them may receive $2.50, etc. In another example, the rule may dictate that the commission for sponsors is 15% of the sale, but only if the sale is over $500; otherwise no commission is paid, the database also includes the type of rule (e.g., “Sponsor”), which indicates that the rule should be used to calculate commissions for sponsors. In some embodiments, multiple rules may exist for one rule type, for example, one rule may apply to sponsors that are also somewhere upline of the user who made the sale, while a different sponsor rule may apply if the sponsor is cross-line, meaning they are not anywhere upline of the user who made the sale.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

1. (canceled)

2. A method for merging at least two user structures into a multiline user structure, the method comprising:
storing information in a database regarding at least a first user structure with a first set of lines corresponding to existing relationships and a second user structure with a second set of lines corresponding to existing relationships;
receiving data for at least one member of the first user structure or the second user structure, the data regarding at least a position of the at least one member within the respective user structure and corresponding to a set of relationships of the at least one member;
merging the first user structure and the second user structure to create a new merged multiline user structure that includes the at least one member, wherein the set of relationships of the at least one member is integrated into and maintained within the merged multiline user structure;
storing the merged multiline user structure in memory, and
generating a simulation that adds one or more additional lines to the merged multiline user structure.

3. The method of claim 2, further comprising tagging the one or more additional lines as temporary.

4. The method of claim 2, further comprising automatically deleting the one or more additional lines from the simulation after a specified period of time.

5. The method of claim 2, wherein generating the simulation further comprises automatically generating example data regarding one or more new members associated with the one or more additional lines.

6. The method of claim 2, wherein automatically generating the example data is based on stored example data from a database.

7. The method of claim 2, further comprising receiving example data from a user input.

8. The method of claim 5, wherein generating the example data is based on historical performance data of the one or more new members prior to the merger, wherein the one or more new members are members of the first user structure or of the second user structure.

9. The method of claim 5, further comprising calculating an expected distribution based on the example data.

10. The method of claim 2, further comprising modifying the set of relationships of the at least one member based the set of relationships exceeding a threshold maximum number.

11. The method of claim 2, further comprising adding one or more additional lines to the merged multiline user structure corresponding to new relationships with the at least one member until a threshold maximum number is reached.

12. The method of claim 11, further comprising raising the threshold maximum number based on threshold criteria being met.

13. The method of claim 12, further comprising identifying that the threshold criteria are met based on weighting one or more of the relationships between the at least one member and one or more members that are downline from the at least one member within the merged multiline user structure.

14. The method of claim 11, wherein adding the additional lines is based on online usage of a unique code associated with the at least one member, and wherein the unique code is an embedded uniform resource location (URL) of a webpage.

15. The method of claim 14, wherein the online usage of the unique code is at the webpage, and further comprising generating a new unique code based on the online usage of the unique code at the webpage by a device of a new member.

16. The method of claim 15, further comprising creating a new relationship between the new member and the at least one member within the merged multiline user structure, and storing information regarding the new relationship in association with the new unique code.

17. The method of claim 14, further comprising identifying one or more relationships with one or more members that are upline from the at least one member within the merged multiline user structure based on the data for the at least one member.

18. The method of claim 17, further comprising associating the at least one member and the upline members with an online interaction based on usage of the unique code during the online interaction.

19. A system for merging at least two multi-level user structures into a multiline user structure, the system comprising:
a first database that stores information regarding a first user structure with a first set of lines corresponding to existing relationships;
a second database that stores information regarding a second user structure with a second set of lines corresponding to existing relationships;
a merger module in communication with the first database and the second database, wherein the merger module is executable by a processor to merge the first user structure and the second user structure to create a new merged multiline user structure that includes at least one member, wherein the set of relationships of the at least one member is integrated into and maintained within the merged multiline user structure;
a multiline database that stores the merged multiline user structure in memory, wherein the merged multiline user structure is updateable to add one or more additional lines in a simulation; and
a simulation module executable by the processor to generate a simulation that adds one or more additional lines to the merged multiline user structure.

20. A non-transitory, computer-readable storage medium, having embodied thereon a program executable by a processor to perform a method for merging at least two multi-level user structures into a multiline user structure, the method comprising:
storing information in a database regarding at least a first user structure with a first set of lines corresponding to existing relationships and a second user structure with a second set of lines corresponding to existing relationships;
receiving data for at least one member of the first user structure or the second user structure, the data regarding at least a position of the at least one member within the respective user structure and corresponding to a set of relationships of the at least one member;
merging the first user structure and the second user structure to create a new merged multiline user structure that includes the at least one member, wherein the set of relationships of the at least one member is integrated into and maintained within the merged multiline user structure;
storing the merged multiline user structure in memory, wherein the merged multiline user structure is updateable to add one or more additional lines in a simulation; and
generating a simulation that adds one or more additional lines to the merged multiline user structure.
